(19) United States
(12) Patent Application Publication
(10) Pub. No.: US 2018/0298831 A1
(43) Pub. Date: Oct. 18, 2018

(54) BYPASS VALVE FOR TURBOCHARGER

(71) Applicant: BorgWarner Inc., Auburn Hills, MI (US)

(72) Inventors: Werner ROTT, Flonheim (DE); Georg SCHOLZ, Woellstein (DE)

(21) Appl. No.: 15/768,033

(22) PCT Filed: Oct. 11, 2016
(86) PCT No.: PCT/US2016/056383

§ 371 Date: Apr. 13, 2018

(30) Foreign Application Priority Data
Oct. 16, 2015 (DE) 102015220225.9

(51) Int. Cl. F02D 9/10; F02B 37/16; F02B 37/18; F16K 1/20

(52) U.S. Cl. CPC F02D 9/1015; F02B 37/16; F02B 37/007; F02D 9/102; F16K 1/20; F02B 37/183

(57) ABSTRACT

A bypass valve for an engine with turbocharging for use in a pipe section of a bypass. The bypass valve has a sealing device which comprises a flap. The flap is mounted to be doubly rotatable via a first axis of rotation and via a second axis of rotation.

### FIELD OF THE INVENTION

The present invention relates to a bypass valve for engines with multiple charging and also a suction tract and an exhaust gas tract with a corresponding bypass valve.

### BACKGROUND INFORMATION

Increasingly more vehicles of the more recent generation are equipped with turbochargers. They have become an important component in future emissions guidelines. In order to achieve the target demands and the cited legal requirements, it is imperative to promote development in the entire drive train and also to optimize the individual components as well as the system as a whole.

Multi-stage, most often two-stage supercharging systems are used as part of the system components for the engine and turbocharger. For example, a two-stage controlled supercharging system comprises two turbochargers (a large, low-pressure exhaust gas turbocharger and a smaller, high-pressure exhaust gas turbocharger). At lower speeds, the high-pressure turbocharger guarantees a fast boost pressure and thus a dynamic start, whereas the large, low-pressure turbocharger is used at higher speeds and is responsible for the high end output at a low-pressure stage. Bypasses with corresponding bypass valves thereby ensure an alignment of the supercharging to the engine operation points on the compressor and on the turbine sides.

Known valve systems are throttle or flap valves which have a circumferential seal; the valve rotates around the main axis of the seal and that axis crosses the sealed area. Linearly functioning check valves represent an alternative valve variant which is pretensioned using a spring. These types of valves require a relatively large installation space.

In order to improve the complete system architecture of the drive train, it is imperative to also optimize the bypass valves for bypasses on the compressor and on the turbine sides. Factors which play a role are, among others, the size (installation space requirement) of the valve, the response characteristic and its determinability, arrangement or installation position, and flow behavior through the valve.

The goal of the present invention is accordingly to provide an optimized bypass valve, which alleviates the disadvantages of the known valves and provides advantages in the area of the factors mentioned above.

### BRIEF SUMMARY OF THE INVENTION

The present invention relates to a bypass valve according to claim 1, a suction tract according to claim 29, an exhaust tract according to claim 32, and a drive unit according to claim 35. [translator note: there are only 33 embodiments and 15 claims]

The bypass valve according to the invention is designed for use in a pipe section of a bypass for an engine with turbocharging. The bypass valve has one sealing device which comprises a flap. The flap is mounted to be doubly rotatable via a first axis of rotation and via a second axis of rotation. Due to the fact that the flap is doubly rotatably mounted about two axes of rotation, a specific kinematics may be realized for the opening action of the flap. This enables an opening action without blocking or jamming the flap. In addition, the specific arrangement has a small installation requirement and thus enables an arrangement of the complete sealing device in a bypass pipe section.

The second axis of rotation may be arranged closer to the flap than the first axis of rotation, at least in the closed state of bypass valve.

In embodiments, at least one projection, in particular two projections may be provided on one surface of the flap, wherein the second axis of rotation extends through the at least one projection. In addition, the sealing device has a pivot pin and a sleeve, wherein the sleeve is rotatably mounted on the pivot pin and the first axis of rotation is defined thereby. In particular, the pivot pin may be arranged at a distance from the first surface. At least one lever arm, preferably two lever arms, my be arranged on the sleeve, wherein the lever arm(s) may be rotatably coupled in a distal region to the projection(s) of the flap, when viewed from the pivot pin, and thus defines the second axis of rotation. At least one spring, which counteracts a rotation of the flap about the first axis of rotation, may be arranged about the pivot pin. The at least one spring may comprise one or two leg springs, wherein each leg of the leg springs may be respectively guided in a receptacle which is arranged on the first surface of the flap. The legs of the leg springs are thereby guided in the receptacles in such a way that they are displaceable in the receptacles during opening of the flap.

In embodiments, which may be combined with all of the previously described embodiments, a stop may be arranged on the first surface of the flap, wherein the stop limits an initial inclination movement of the flap during opening, in particular wherein the stop strikes the lever arm(s) during opening and thus a predetermined maximum inclination angle of the flap is defined for the initial inclination movement at the beginning of the opening action. After the stop has struck the lever arm(s), further opening of the flap may be carried out by rotating the lever arm(s) about the first axis of rotation.

In embodiments, which may be combined with all of the previously described embodiments, the bypass valve may additionally comprise a pipe section of a bypass, wherein the flap is arranged in the pipe section. The first axis of rotation and the second axis of rotation may extend perpendicular to a center axis of the pipe section. At least one of the first and the second axes of rotation may extend offset with respect to the center axis of the pipe section. In particular, both the first and also the second axes of rotation may extend offset with respect to the center axis of the pipe section, wherein the center axis of the pipe section extends between the first and second axes of rotation. The first axis of rotation and the second axis of rotation may extend, in the closed state of the bypass, in such a way that an imaginary connecting line, which connects the first axis of rotation and the second axis of rotation and intersects the center axis of the pipe section, does not intersect the center axis at a 90° angle. The second axis of rotation may change its position in the pipe section during the movement of the flap. The first axis of rotation may be arranged in such a way in the pipe section that it does not change the position thereof in the pipe section during movement of the flap. The pivot pin of the first axis of rotation may be arranged in two receptacles, wherein the two receptacles are fixed in the wall of the pipe section or are formed integrally with the same. The pipe section may have a first inner diameter and a second inner diameter, wherein the first inner diameter is larger than the second inner diameter. The sealing device may be arranged at least partially in the region of the first inner diameter. A transition region of the pipe section from the first inner diameter to the second inner diameter may be configured conically and define a conical seat. In embodiments, the pipe section may be composed from a first component, a second component, and a third component. The first component is arranged between the second component and the third component. A configuration of this type is advantageous for the assembly. The first and the second axes of rotation may be arranged in the region of the first component. In addition, the receptacles for the pin may be positioned in the region of the first component. The first component may have an inner diameter of D1, the second component and the third components may have an inner diameter D2 and D3, which are smaller than D1. In each case, one end of the second component and of the third component, which contact first the component 202, may have a transition region in which the respective inner diameter of D2 or D3 is increased to D1. D2 and D3 may be equally large. The transition region of the second component is configured conically and may define a conical seat. The flap may contact on the conical seat in the closed state of the bypass valve and thus prevent a fluid flow through the pipe section. The flap may have a circular shape, wherein a sealing ring may be arranged circumferentially around the circumference of the flap, and wherein the sealing ring may contact on the conical seat in the closed state.

In embodiments, which may be combined with all of the previously described embodiments, the flap may initially be inclined at a predetermined angle during the opening of the bypass valve, in particular at a contact point between the flap or the sealing ring and the pipe section, in order to be able to subsequently rotate freely about the first axis of rotation.

In embodiments, which may be combined with all of the previously described embodiments, the bypass valve may be self-regulating, preferably pressure-regulated, in particular via the air pressure of the air flow contacting the flap. The flap of the bypass valve accordingly opens until an equilibrium state exists between the force generated by the air pressure of the airflow at the flap (air pulse) and the force of the spring(s).

Advantages of the bypass valve according to the invention are, in particular, a smaller installation space or spatial requirement for the installation, since the axis of rotation or axes of rotation of the flap are arranged in the pipe section. In addition, the forces which must be applied for opening the flap may be variably determined due to the targeted arrangement of the axes of rotation, and the selection of the leg springs.

Furthermore, the bypass valve has advantageous throughflow characteristics (linear flow). In particular, the sealing device of the bypass valve scarcely blocks the throughflow through the pipe section in the completely open position.

The invention additionally comprises a suction tract for an engine comprising a bypass valve according to any of the previously described embodiments. This type of suction tract may comprise a two-stage supercharging system, in particular wherein the two-stage supercharging system comprises a low-pressure exhaust gas turbocharger and a high-pressure turbocharger. The bypass valve may be arranged in a compressor bypass of the two-stage supercharging system in such a way that air is guided through the compressor bypass and around a compressor wheel of the high-pressure exhaust gas turbocharger when the bypass valve is open.

The invention additionally comprises an exhaust gas tract for an engine comprising a bypass valve according to any of the previously described embodiments. This type of exhaust gas tract may comprise a two-stage supercharging system, in particular wherein the two-stage supercharging system comprises a low-pressure exhaust gas turbocharger and a high-pressure turbocharger. The bypass valve may be arranged in a turbine bypass of the two- stage supercharging system in such a way that air is guided through the turbine bypass and around a turbine wheel of the high-pressure exhaust gas turbocharger when the bypass valve is open.

The invention additionally comprises a drive unit for a motor vehicle comprising a previously described suction tract and/or a previously described exhaust gas tract.

### BRIEF DESCRIPTION OF THE DRAWINGS

FIG. 1 shows a top view of the bypass valve according to the invention according to one embodiment;

FIG. 2A shows a partial view of the bypass valve according to the invention according to the embodiment from FIG. 1 in the closed state;

FIGS. 2B through 2D show partial views of the bypass valve according to the invention according to the embodiment from FIG. 1 in different states during the opening action.

### DETAILED DESCRIPTION OF THE INVENTION

In the following, an embodiment of the bypass valve according to the invention will be described by means of the figures.

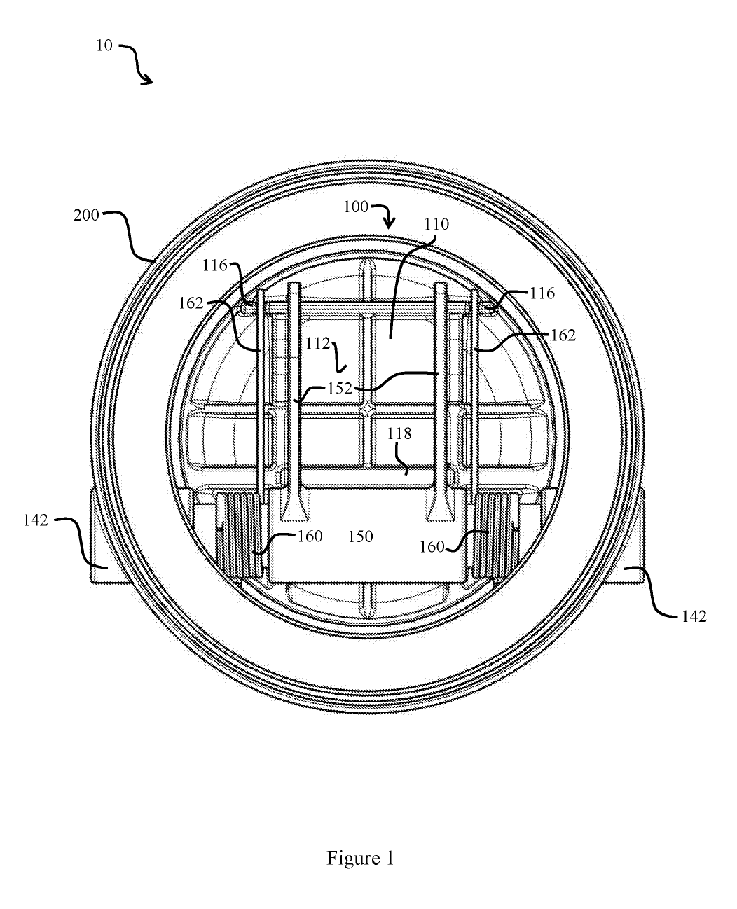

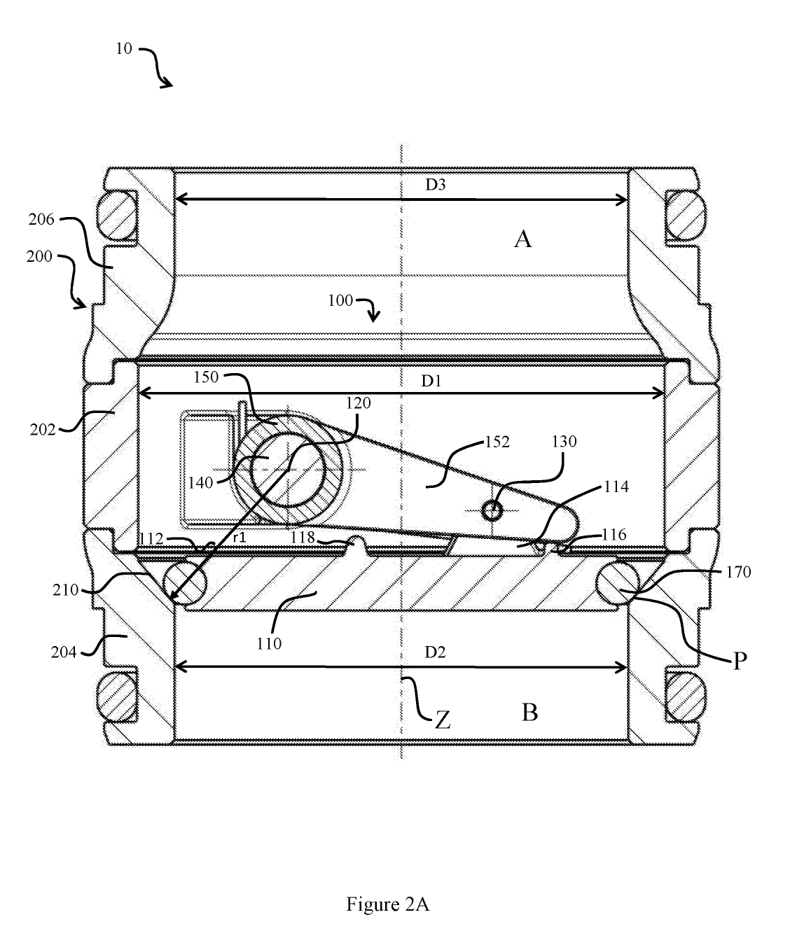

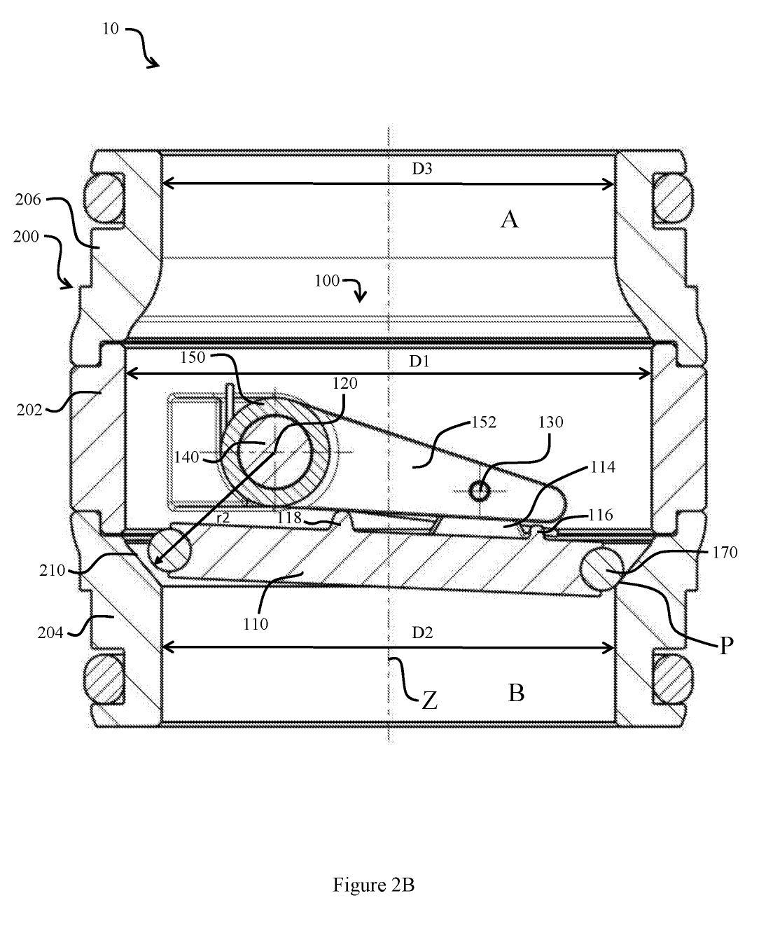

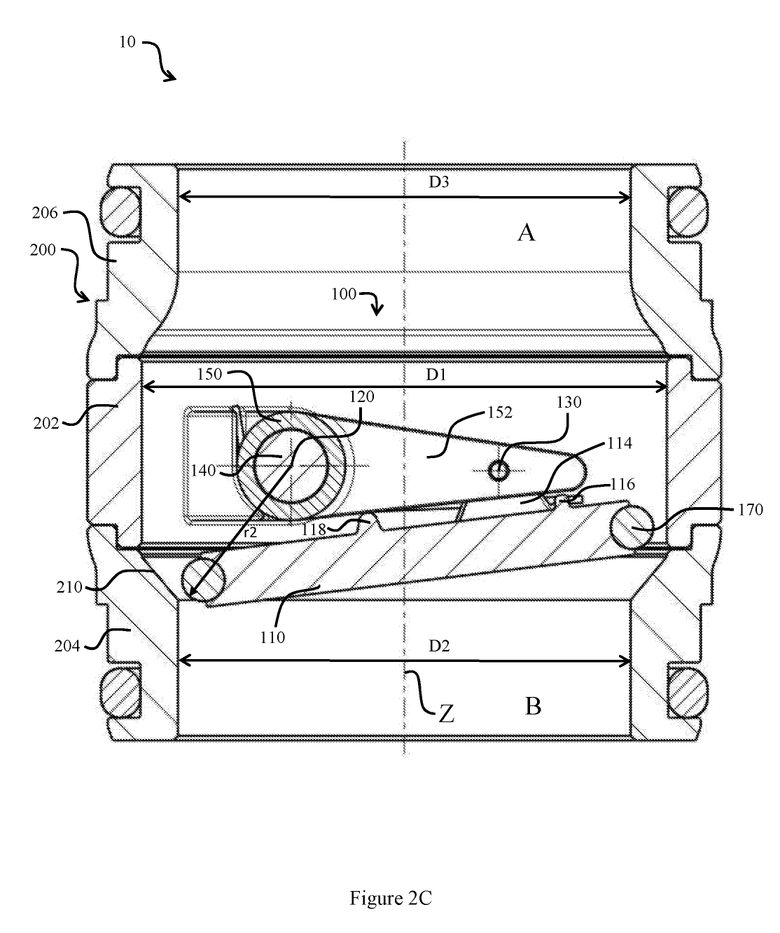

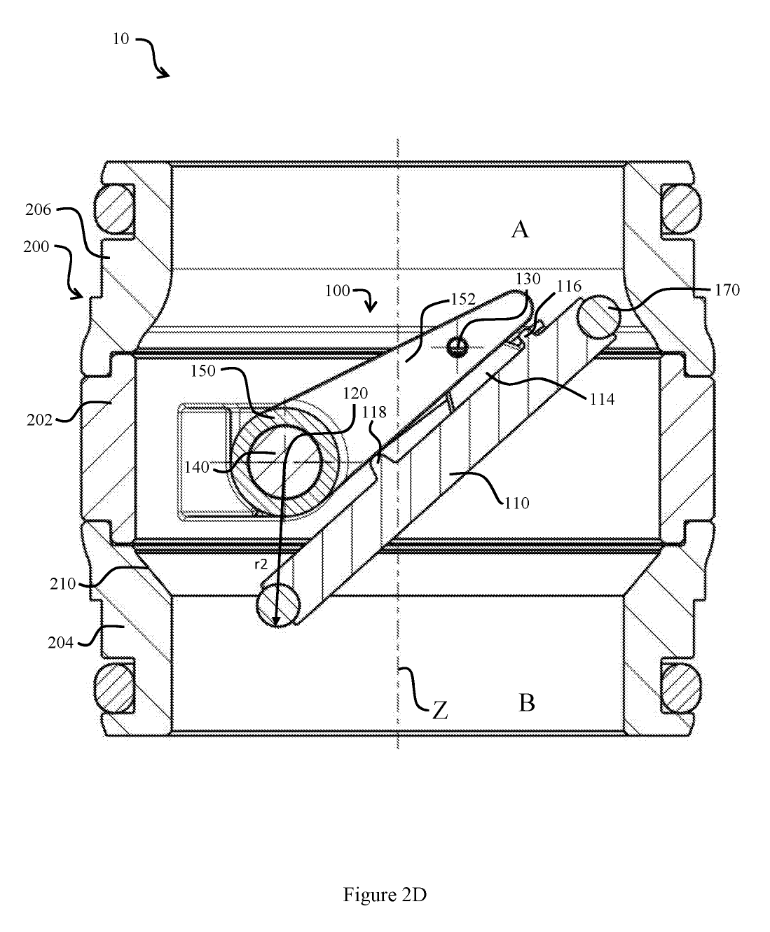

FIG. 1 shows an embodiment according to the invention of bypass valve 10 for an engine with turbocharging in a top view. Bypass valve 10 is designed for use in a pipe section 200 of a bypass, e.g. in order to bypass a compressor wheel of a turbocharger or to bypass a turbine wheel of a turbocharger. Bypass valve 10 has a sealing device 100 which comprises a flap 110. As is especially clear in FIGS. 2A through 2D, flap 110 is mounted to be doubly rotatable via a first axis of rotation 120 and via a second axis of rotation 130. This enables a specific kinematics for implementing the opening action of flap 110, which enables an opening action without blocking or jamming flap 110 in pipe section 200 (see detailed description of the opening action further below). In addition, the specific arrangement has a small installation requirement and thus enables an arrangement of complete sealing device 100 in a bypass pipe section 200.

As is clear from FIG. 2A, in the closed state of bypass valve 10, second axis of rotation 130 is arranged closer to flap 110 than first axis of rotation 120.

Two projections 114 are provided on a first surface 112 of flap 110 (in FIGS. 2A through 2D, only one is evident, since second projection 114 is hidden by first projection 114). Second axis of rotation 130 extends through both projections 114. In addition, sealing device 100 has a pivot pin 140 and a sleeve 150, wherein sleeve 150 is rotatably mounted on pivot pin 140 and first axis of rotation 120 is defined thereby. In the cutaway drawings of FIGS. 2A through 2D, it is clear that pivot pin 140 is arranged at a distance from first surface 112. Projections 114 and pivot pin 140 of first axis of rotation 120 are located on the same side of flap 110, specifically on the side of first surface 112. Two lever arms 152 are arranged on sleeve 150. Lever arms 152 are rotatably coupled to projections 114 of flap 110 in a distal region when viewed from pivot pin 140. Second axis of rotation 130 is defined thereby. The coupling is arranged, for example, in the distal half of lever arms 152, in particular in the distal third of lever arm 152. The rotatable coupling between lever arms 152 and projections 114 may be realized, for example, via a hole-pin connection. Alternatively, the rotatable coupling may be carried out via axle projections, integrally provided on lever arms 152 (or projections 114), which engage in corresponding holes in projections 114 (or lever arms 152).

As is especially clear in FIG. 1, two leg springs 160 are arranged around pivot pin 140, which counteract a rotation of flap 110 about first axis of rotation 120. One leg 162 respectively of the leg springs is respectively guided in a receptacle 116 which is arranged on first surface 112 of flap 110. Legs 162 of leg springs 160 are thereby guided in receptacles 116 in such a way that they are displaceable in receptacles 116 during opening of flap 110. This means that legs 162 move during opening and sealing of flap 110 in the direction of the longitudinal axis of legs 162 in receptacles 116. Second, shorter legs of leg springs 160 (for example, clearly depicted in FIG. 2A parallel to the center axis Z at the left upper corner of sleeve 150) respectively prevent a co-rotation of leg springs 160 around pin 140 during opening of flap 110. Thus, a force is generated, via the spring force of leg springs 160, which counteracts the rotation of flap 110 about first axis of rotation 120.

A stop 118 is arranged on first surface 112 of flap 110. Stop 118 limits an initial inclination movement of flap 110 upon opening in that it strikes lever arm 152 (see FIG. 2B). By this means, a predetermined maximum inclination angle of flap 110 is defined for the initial inclination movement at the beginning of the opening action. After stop 118 has struck lever arm 152, further opening of flap 110 is carried out by rotating lever arm 152 about first axis of rotation 120 (additional details regarding the opening kinematics are further below).

Sealing device 100 of bypass valve 10 is arranged in a pipe section 200 of a bypass. First axis of rotation 120 and second axis of rotation 130 extend perpendicular to a center axis Z of pipe section 200 (see e.g. FIG. 2A). In addition, both axes of rotation 120, 130 extend parallel to one another and both first axis of rotation 120 and also second axis of rotation 130 are arranged offset with respect to center axis Z of pipe section 200, wherein center axis Z of pipe section 200 extends between first and second axes of rotation 120, 130. This means that the two axes of rotation do not intersect with one another and also do not intersect with center axis Z. First axis of rotation 120 and second axis of rotation 130 extend, in the closed state of bypass valve 10, in such a way that an imaginary connecting line, which connects first axis of rotation 120 and second axis of rotation 130 and intersects center axis Z of pipe section 200, does not intersect center axis Z at a 90° angle.

During movement of flap 110 (for opening or closing), second axis of rotation 130 changes the position thereof in pipe section 200 (see corresponding position of second axis of rotation 130 in FIGS. 2A through 2D). In contrast, first axis of rotation 120 is arranged in such a way in pipe section 130 that it does not change the position thereof in pipe section 200 during movement of flap 110. Pivot pin 140 of first axis of rotation 120 is arranged for this purpose in two receptacles 142. The pivot pin may, for example, be fixed in two receptacles 142 via a press fit. Two receptacles 142 may be fixed in the wall of pipe section 200 or integrally formed in the same.

Pipe section 200 has a first inner diameter D1 and a second inner diameter D2. In the embodiment shown in FIGS. 2A bis 2D, pipe section 200 is composed from a first component 202, a second component 204, and a third component 206. In alternative embodiments, pipe section 200 may also be formed as one piece. In the embodiment shown, first component 202 is arranged between second component 204 and third component 206. A configuration of this type is advantageous for the assembly. First and second axes of rotation 120, 130 are arranged in the region of first component 202 in the closed state. In addition, receptacles 142 for pivot pin 140 are positioned in the region of first component 202. First component 202 has an inner diameter D1. Second component 204 and third component 206 have an inner diameter D2 and D3, which are smaller than D1. In each case, one end of second component 204 and of third component 206, which contacts first component 202, has a transition region in which the respective inner diameter of D2 or D3 is increased to D1. D2 and D3 may be equally large. The transition region of second component 204 is configured conically and defines a conical seat 210. As is apparent in FIG. 1, flap 110 of the embodiment shown is circular, wherein a sealing ring 170 is arranged circumferentially around the circumference of flap 110 (see FIGS. 2A through 2D). Sealing ring 170 contacts conical seat 210 in the closed state of flap 110 (see FIG. 2A). By this means, fluid flow through pipe section 200 is prevented. The material for sealing ring 170 may be selected depending on the application for which the bypass valve is provided (compressor bypass, turbine bypass). For applications in which the temperatures do not become too high, O-rings, for example, made from an elastomer, may be used. For high temperature applications in turbine bypasses, which are subjected to exhaust gasses of 900 degrees and higher, temperature-resistant metal sealing rings 170, for example, may be used.

The kinematics of sealing device 100 or of flap 110 during opening of bypass valve 10 will be subsequently described in greater detail by means of FIGS. 2A through 2D. As is apparent in FIG. 2A, sealing ring 170, as described above, for example, a sealing ring 170 made from elastomer for use in a compressor bypass or a sealing ring 170 made from a heat-resistant material (e.g. a metal) for use in a turbine bypass, is arranged centered in conical seat 210 in the closed state and thus prevents an air flow through bypass valve 10. This means, in the closed position of bypass valve 10 or of flap 110, the pressure in pipe section 200 in the region downstream of flap 110 (region A) is always greater than the pressure in the region of pipe section 200 upstream of flap 110 (region B). A pressure difference is present in the contact region of flap 110 or of sealing ring 170 of flap 110 with conical seat 210 of pipe section 200. In addition, leg springs 160 arranged around pivot pin 140, which defines first axis of rotation 120, exert a contact force at the contact point of the leg springs in corresponding receptacle 116, which force counters a rotational movement of sleeve 150 or of lever arms 152 about first axis of rotation 120. Flap 110 itself is rotatably mounted on lever arms 152 via corresponding projections 114 on first surface 112 of flap 110 and defines second axis of rotation 130 via this mounting. During an attempt to rotate lever arms 152 with flap 110 about first axis of rotation 120 in order to open bypass valve 10, an arrangement without second axis of rotation 130 would jam with conical seat 210, since radius r1 (see FIG. 2A) is too large for the rotational movement about first axis of rotation 120 to permit a clear rotation of flap 110 out of the closed position. Second axis of rotation 130 in the coupling region between lever arm 152 and flap 110 and the specific design of sealing device 100 solve this problem through the following advantages: Flap 110 is loaded with a spring force at the contact points of leg springs 160 in receptacles 116. Legs 162 of leg springs 160 may, however, longitudinally displace in the respective receptacle 116. In the case where the pressure in region B upstream of flap 110 exceeds the pressure in region A downstream of flap 110, flap 110 initially inclines about contact point P until stop 118 of flap 110 strikes lever arm 152 (see FIG. 2B). The initial inclination movement of flap 110 about contact point P is thus ended. During this inclination movement, both a rotation about first axis of rotation 120 and also a rotation about second axis of rotation 130 additionally occur. In addition, second axis of rotation 130 displaces itself within pipe section 200. Subsequently, flap 110 moves synchronously with lever arm 152 about first axis of rotation 120 against the spring force for additional opening (see FIG. 2B). This is enabled by the particular kinematics of sealing device 100. Due to the initial inclination movement of flap 110 about contact point P, the spacing of flap 110 to first axis of rotation 120 changes in certain regions of flap 110. This results in radius r2 (see FIG. 2B) for the rotational movement about first axis of rotation 120, wherein radius r2 is smaller than radius r1. Smaller radius r2 now enables flap 110 to pivot through the sealing region without any contact with the pipe section wall or conical seat 210 (see FIG. 2C), by which means bypass valve 10 is further opened. FIG. 2D shows the bypass valve in an open position. Bypass valve 10 thereby always opens until an equilibrium state exists between the force generated by the air pressure of the airflow at flap 110 (air pulse) and the force of springs 160.

Advantages of this design are, in particular, a smaller installation space or spatial requirement for the installation, since axis of rotation or axes of rotation 120, 130 of flap 110 are arranged in pipe section 200. In addition, the forces which must be applied for opening flap 110 may be variably determined due to the targeted arrangement of axes of rotation 120, 130 and the selection of the characteristics of leg springs 160.

Furthermore, bypass valve 10 has advantageous throughflow characteristics (linear flow). In particular, sealing device 100 of bypass valve 10 scarcely blocks the throughflow through pipe section 200 in the completely open position.

FIGS. 1 through 2D show an embodiment of bypass valve 10 which is self regulating. These types of embodiments are preferably pressure regulated, in particular via the air pressure of the airflow applied at flap 110. Flap 110 of bypass valve 10 accordingly opens until an equilibrium state exists between the force generated by the air pressure of the airflow at flap 110 (air pulse) and the force of springs 160.

The invention additionally comprises a suction tract for an engine which comprises a bypass valve 10 as described herein. This type of suction tract may comprise a two-stage supercharging system, in particular wherein the two-stage supercharging system comprises a low-pressure exhaust gas turbocharger and a high-pressure turbocharger. Bypass valve 10 may be arranged in a compressor bypass of the two-stage supercharging system in such a way that air is guided through the compressor bypass and around a compressor wheel of the high-pressure exhaust gas turbocharger when bypass valve 10 is open.

In addition, the invention comprises an exhaust gas tract for an engine which comprises a bypass valve 10 as described herein. This type of exhaust gas tract may comprise a two-stage supercharging system, in particular wherein the two-stage supercharging system comprises a low-pressure exhaust gas turbocharger and a high-pressure turbocharger. Bypass valve 10 may be arranged in a turbine bypass of the two-stage supercharging system in such a way that air is guided through the turbine bypass and around a turbine wheel of the high-pressure exhaust gas turbocharger when bypass valve 10 is open.

The invention additionally comprises a drive unit for a motor vehicle comprising a previously described suction tract and/or a previously described exhaust gas tract.

Although the present invention has been described and is defined in the attached claims, it should be understood that the invention may also be alternatively defined according to the following embodiments:
1. A bypass valve (10) for an engine with turbocharging for use in a pipe section (200) of a bypass comprising
   a sealing device (100) which has a flap (110),
   characterized in that the flap (110) is mounted to be doubly rotatable via a first axis of rotation (120) and via a second axis of rotation (130).
2. The bypass valve according to Embodiment 1, characterized in that the second axis of rotation (130) is arranged closer to the flap (110) than the first axis of rotation (120), at least in the closed state of the bypass valve (10).
3. The bypass valve according to Embodiment 1 or Embodiment 2, characterized in that at least one projection (114), in particular two projections (114) is/are provided on a first surface (112) of the flap (110), wherein the second axis of rotation (130) extends through the at least one projection (114).
4. The bypass valve according to Embodiment 3, characterized in that the sealing device (100) has a pivot pin (140) and a sleeve (150), wherein the sleeve (150) is rotatably mounted on the pivot pin (140) and the first axis of rotation (120) is defined thereby, in particular wherein the pivot pin (140) is arranged at a distance from the first surface (112).
5. The bypass valve according to Embodiment 4, characterized in that at least one lever arm (152), preferably two lever arms (152), is/are arranged on the sleeve (150), wherein the lever arm(s) (152) are rotatably coupled in a distal region to the projection(s) (114) of the flap (110), when viewed from the pivot pin (140), and thus define the second axis of rotation (130).
6. The bypass valve according to any one of Embodiments 4 through 5, characterized in that at least one spring (160), which counteracts a rotation of the flap (110) about the first axis of rotation (120), is arranged around the pivot pin (160).
7. The bypass valve according to Embodiment 6, characterized in that the at least one spring (160) comprises one or two leg springs (160), wherein each leg (162) of the leg springs is respectively guided in a receptacle (116) which is arranged on the first surface (112) of the flap (110).
8. The bypass valve according to Embodiment 7, characterized in that the legs (162) of the leg springs (160) are guided in the receptacles (116) in such a way that they are displaceable in the receptacles (116) during opening of the flap (110).
9. The bypass valve according to any one of Embodiments 3 through 8, characterized in that a stop (118) is arranged on the first surface (112) of the flap (110), wherein the stop (118) limits an initial inclination movement of the flap (110) during opening, in particular wherein the stop (118) strikes the lever arm(s) (152) during opening and thus a predetermined maximum inclination angle of the flap (110) is defined for the initial inclination movement at the beginning of the opening action.
10. The bypass valve according to Embodiment 9, characterized in that after the stop (118) has struck the lever arm(s) (152), further opening of the flap (110) is carried out by rotating the lever arm(s) (152) about the first axis of rotation (120).
11. The bypass valve according to any one of the preceding embodiments, characterized in that the bypass valve (10) additionally comprises a pipe section (200) of a bypass, wherein the flap (110) is arranged in the pipe section (200).
12. The bypass valve according to Embodiment 11, characterized in that the first axis of rotation (120) and the second axis of rotation (130) extend perpendicular to a center axis (Z) of the pipe section (200).
13. The bypass valve according to Embodiment 11 or Embodiment 12, characterized in that at least one of the first and the second axes of rotation (120, 130) extend offset with respect to a center axis (Z) of the pipe section (200).
14. The bypass valve according to Embodiment 13, characterized in that both the first and also the second axes of rotation (120, 130) extend offset with respect to the center axis (Z) of the pipe section (200), wherein the center axis (Z) of the pipe section (200) extends between the first and second axes of rotation (120, 130).
15. The bypass valve according to any one of Embodiments 11 through 14, characterized in that the first axis of rotation (120) and the second axis of rotation (130) extend, in the closed state of the bypass valve (10), in such a way that a connecting line, which connects the first axis of rotation (120) and the second axis of rotation (130) and intersects the center axis (Z) of the pipe section (200), does not intersect the center axis (Z) at a 90° angle.
16. The bypass valve according to any one of Embodiments 11 through 15, characterized in that the second axis of rotation (130) changes its position in the pipe section (200) during the movement of the flap (110).
17. The bypass valve according to any one of embodiments 11 through 16, characterized in that the first axis of rotation (120) is arranged in the pipe section (130 [sic:200]) in such a way that it does not change its position in the pipe section (200) during movement of the flap (110).
18. The bypass valve according to any one of Embodiments 11 through 17, characterized in that the pivot pin (140) of the first axis of rotation (120) is arranged in two receptacles (142), wherein the two receptacles (142) are fixed in the wall of the pipe section (200) or are formed integrally with the same.
19. The bypass valve according to any one of Embodiments 11 through 18, characterized in that the pipe section (200) has a first inner diameter (D1) and a second inner diameter (D2), wherein the first inner diameter (D1) is larger than the second inner diameter (D2).
20. The bypass valve according to Embodiment 19, characterized in that the sealing device (100) is arranged at least partially in the region of the first inner diameter (D1).
21. The bypass valve according to any one of Embodiments 19 through 20, characterized in that a transition region of the pipe section from the first inner diameter (D1) to the second inner diameter (D2) is configured conically and defines a conical seat (210).
22. Thy bypass valve according to Embodiment 21, characterized in that the flap (110) contacts the conical seat (210) in the closed state of the bypass valve (10) and thus prevents a fluid throughflow through the pipe section (200).
23. The bypass valve according to any one of Embodiments 21 through 22, characterized in that the flap (110) has a circular shape, wherein a sealing ring (170) is arranged circumferentially around the circumference of the flap (110), and wherein the sealing ring (170) contacts on the conical seat (210) in the closed state.
24. The bypass valve according to any one of Embodiments 11 through 23, characterized in that the flap (110) initially inclines at a predetermined angle during opening of the bypass valve (10), in particular at a contact point (P) between the flap (110) or the sealing ring (170) and the pipe section (200), in order to be able to subsequently rotate freely about the first axis of rotation (120).
25. The bypass valve according to any one of the preceding embodiments, characterized in that the bypass valve (10) is self-regulating, preferably pressure-regulated, in particular via the air pressure of the air flow contacting the flap (110).
26. The bypass valve according to any one of Embodiments 6 through 25, characterized in that the flap (110) of the bypass valve (10) opens until an equilibrium state exists between the force generated by the air pressure of the airflow at the flap and the force of the spring (160) or springs (160).
27. A suction tract for an engine with a bypass valve (10) according to any one of Embodiments 1 through 26.
28. The suction tract according to Embodiment 27, additionally comprising a two-stage supercharging system, in particular wherein the two-stage supercharging system comprises a low-pressure exhaust gas turbocharger and a high-pressure exhaust gas turbocharger.
29. The suction tract according to Embodiment 28, characterized in that the bypass valve (10) is arranged in a compressor bypass of the two-stage supercharging system in such a way that air is guided through the compressor bypass and around a compressor wheel of the high-pressure exhaust gas turbocharger when the bypass valve (10) is open.
30. An exhaust gas tract for an engine with a bypass valve (10) according to any one of Embodiments 1 through 26.
31. The exhaust gas tract according to Embodiment 30, additionally comprising a two-stage supercharging system, wherein the two-stage supercharging system comprises a low-pressure exhaust gas turbocharger and a high-pressure exhaust gas turbocharger.
32. The exhaust gas tract according to Embodiment 31, characterized in that the bypass valve (10) is arranged in a turbine bypass of the two-stage supercharging system in such a way that air is guided through the turbine bypass and around a turbine of the high-pressure exhaust gas turbocharger when the bypass valve (10) is open.
33. A drive unit for a motor vehicle with a suction tract according to any one of Embodiments 27 through 29 and/or with an exhaust gas tract according to any one of Embodiments 30 through 32.

1. A bypass valve (10) for an engine with turbocharging for use in a pipe section (200) of a bypass comprising
a sealing device (100) which has a flap (110),
wherein the flap (110) is mounted to be doubly rotatable via a first axis of rotation (120) and via a second axis of rotation (130).

2. The bypass valve according to claim 1, characterized in that wherein at least one projection (114), is provided on a first surface (112) of the flap (110), and wherein the second axis of rotation (130) extends through the at least one projection (114).

3. The bypass valve according to claim 2, wherein the sealing device (100) has a pivot pin (140) and a sleeve (150), and wherein the sleeve (150) is rotatably mounted on the pivot pin (140) and the first axis of rotation (120) is defined thereby.

4. The bypass valve according to claim 3, wherein at least one lever arm (152), is arranged on the sleeve (150), and wherein the lever arm(s) (152) are rotatably coupled in a distal region with the projection(s) (114) of the flap (110), when viewed from the pivot pin (140), and thus define the second axis of rotation (130).

5. The bypass valve according to claim 3, wherein at least one spring (160), which counteracts a rotation of the flap (110) about the first axis of rotation (120), is arranged around the pivot pin (160).

6. The bypass valve according to claim 5, wherein the at least one spring (160) comprises one or two leg springs (160), and wherein each leg (162) of the leg springs is respectively guided into a receptacle (116) which is arranged on the first surface (112) of the flap (110), in particular wherein the legs (162) of the leg springs (160) are thereby guided in the receptacles (116) in such a way that they are displaceable in the receptacles (116) during opening of the flap (110).

7. The bypass valve according to claim 2, wherein a stop (118) is arranged on the first surface (112) of the flap (110), and wherein the stop (118) limits an initial inclination movement of the flap (110) during opening and thus a predetermined maximum inclination angle of the flap (110) is defined for the initial inclination movement at the beginning of the opening action.

8. The bypass valve according to claim 7, wherein after the stop (118) has struck the lever arm(s) (152), further opening of the flap (110) is carried out by rotating the lever arm(s) (152) about the first axis of rotation (120).

9. The bypass valve according to claim 1, wherein the bypass valve (10) additionally comprises a pipe section (200) of a bypass, wherein the flap (110) is arranged in the pipe section (200), wherein both the first and also the second axes of rotation (120, 130) extend offset with respect to the center axis (Z) of the pipe section (200), and wherein the center axis (Z) of the pipe section (200) extends between the first and second axes of rotation (120, 130).

10. The bypass valve according to claim 9, wherein the second axis of rotation (130) changes its position in the pipe section (200) during the movement of the flap (110); in particular wherein the first axis of rotation (120) is arranged in such a way in the pipe section (130 [sic:200]) that it does not change the position thereof in the pipe section (200) during movement of the flap (110).

11. The bypass valve according to claim 9, wherein the pivot pin (140) of the first axis of rotation (120) is arranged in two receptacles (142), wherein the two receptacles (142) are fixed in the wall of the pipe section (200) or are formed integrally with the same.

12. The bypass valve according to claim 9, wherein the pipe section (200) has a first inner diameter (D1) and a second inner diameter (D2), wherein the first inner diameter (D1) is larger than the second inner diameter (D2); and wherein the sealing device (100) is arranged at least partially in the region of the first inner diameter (D1).

13. The bypass valve according to claim 12, wherein a transition region of the pipe section from the first inner diameter (D1) to the second inner diameter (D2) is configured conically and defines a conical seat (210); wherein a sealing ring (170) is arranged circumferentially around the circumference of the flap (110), and wherein the sealing ring (170) contacts on the conical seat (210) in the closed state.

14. The bypass valve according to claim 9, wherein the flap (110) initially inclines at a predetermined angle during opening of the bypass valve (10), at a contact point (P) between the flap (110) or the sealing ring (170) and the pipe section (200), in order to be able to subsequently rotate freely about the first axis of rotation (120).

15. A drive unit for a motor vehicle with at least one of a suction tract for an engine comprising a bypass valve (10) according to claim 1 and with an exhaust gas tract for an engine comprising a bypass valve (10) according to claim 1.

16. The bypass valve according to claim 1, wherein two projections (114) are provided on a first surface (112) of the flap (110), and wherein the second axis of rotation (130) extends through the at least one projection (114).

17. The bypass valve according to claim 2, wherein the sealing device (100) has a pivot pin (140) and a sleeve (150), wherein the sleeve (150) is rotatably mounted on the pivot pin (140) and the first axis of rotation (120) is defined thereby, and wherein the pivot pin (140) is arranged at a distance from the first surface (112).

18. The bypass valve according to claim 3, wherein two lever aims (152) are arranged on the sleeve (150), and wherein the two lever arms (152) are rotatably coupled in a distal region with the projection(s) (114) of the flap (110), when viewed from the pivot pin (140), and thus define the second axis of rotation (130).

19. The bypass valve according to claim 5, wherein the at least one spring (160) comprises one or two leg springs (160), wherein each leg (162) of the leg springs is respectively guided into a receptacle (116) which is arranged on the first surface (112) of the flap (110), and wherein the legs (162) of the leg springs (160) are thereby guided in the receptacles (116) in such a way that they are displaceable in the receptacles (116) during opening of the flap (110).

20. The bypass valve according to claim 12, wherein a transition region of the pipe section from the first inner diameter (D1) to the second inner diameter (D2) is configured conically and defines a conical seat (210); wherein the flap (110) has a circular shape, wherein a sealing ring (170) is arranged circumferentially around the circumference of the flap (110), and wherein the sealing ring (170) contacts on the conical seat (210) in the closed state.
